(19) United States
(12) Patent Application Publication
(10) Pub. No.: US 2005/0021449 A1
(43) Pub. Date: Jan. 27, 2005

(54) Methods and systems for online management of construction assets

(76) Inventor: Thomas Sweeney, Royersford, PA (US)

Correspondence Address: LAW OFFICE OF BARRY R LIPSITZ, 755 MAIN STREET, MONROE, CT, 06468, US

(21) Appl. No.: 10/898,096

(22) Filed: Jul. 22, 2004

Related U.S. Application Data
(60) Provisional application No. 60/490,107, filed on Jul. 25, 2003.

(51) Int. Cl. G06F 17/60

(52) U.S. Cl. 705/37

(57) ABSTRACT

The present invention provides methods and systems for online management of construction assets. An online inspection report relating to a current condition of a construction asset is provided. The inspection report is archived (e.g., uploaded to a database accessible via a server). An asset owner is then provided with online access to the archived inspection report. The inspection report may include a description of the construction asset, recommendations regarding maintenance of the construction asset, recommendations regarding current repairs to the construction asset, photographs of the construction asset, video clips of the construction asset, design drawings of the construction asset, design specifications of the construction asset, repair history, defect history, maintenance history, and the like. A plurality of inspection reports corresponding to a plurality of construction assets of the asset owner may be archived. Computerized reports may be generated relating to one or more of the plurality of construction assets.

This application claims the benefit of U.S. provisional patent application No. 60/490,107 filed on Jul. 25, 2003, entitled “Methods and Systems For Designing and Bidding On Construction Projects and Managing Construction Assets,” which is incorporated herein and made a part hereof by reference for all purposes as if fully set forth herein.

### BACKGROUND OF THE INVENTION

The present invention relates to the field of construction. In particular, the present application provides methods and systems for the online condition management of a construction asset. The present invention enables online monitoring of the condition of construction asset, such as a building, a roof, a parking lot, or the like. The invention also provides an Internet based design and bid procurement process that is linked to the condition management system to enable online bidding on a construction project. The present invention is applicable to a wide variety of construction projects and assets.

An asset manager of a large corporation may be responsible for monitoring and maintaining the condition of a large number of construction assets across the country or around the world. For example, one corporation may own or lease hundreds of stores around the country, with one person being responsible for the management and maintenance of the roofs of each of these buildings. Currently, an up-to-date roof condition report may cost thousands of dollars per roof. These reports may be issued by separate roofing contractors around the country for the different buildings owned by the corporation. These reports from different companies may be formatted differently and contain disparate information. These reports are typically provided to the asset manager in paper format. There is no convenient way for a large company to organize and manage a large number of assets based on such different reports.

In addition, construction and/or repair projects are typically designed and bid on using plan drawings (e.g., Computer Aided Design (CAD) drawings) and/or by taking physical measurements on the job site. This process usually requires a substantial amount of time for preparing and delivering drawings and specifications for the project, contacting individual contractors to bid on the project, scheduling meetings with the contractors, traveling to the construction site, reviewing and comparing individual bids, selecting a desired bid, contacting the contractor to award the bid, and scheduling the start of the project with the winning contractor. Therefore, the typical bidding process normally results in substantial delay even before physical work on the project has started. Further, due to the logistics involved, most construction projects are sent out to bid to only two or three contractors.

It would be advantageous to provide methods and systems for the online management of a construction asset. It would be further advantageous to streamline the time period required for bidding on a construction project, while at the same time obtaining bids from a larger number of contractors. It would be advantageous to provide a more competitive bidding environment for construction projects and to thereby reduce project costs. It would be further advantageous to provide an easy to use system for maintaining, managing, monitoring, and repairing a construction asset.

The present invention provides the foregoing and other advantages. The present invention advantageously utilizes the information sharing power of the Internet in the construction industry by providing an online process for designing, bidding on, and managing a construction asset which makes it possible for the asset owner to easily manage a large number of assets and to get the very best price for their construction project though competitive bidding.

### SUMMARY OF THE INVENTION

The present invention provides methods and systems for online management of construction assets. In an example embodiment the present invention, a computerized method for the online management of a construction asset is provided. In accordance with the example embodiment, an online inspection report relating to a current condition of a construction asset is provided. The inspection report is archived (e.g., uploaded to a database accessible via a server). An asset owner is then provided with online access to the archived inspection report.

The inspection report may include at least one of a description of the construction asset, recommendations regarding maintenance of the construction asset, recommendations regarding current repairs to the construction asset, photographs of the construction asset, video clips of the construction asset, design drawings of the construction asset, design specifications of the construction asset, repair history, defect history, maintenance history, and the like.

Sections of the design drawings may include hyperlinks to at least one of the photographs and the video clips that show a portion of the construction asset corresponding to the section of the drawing.

In a further example embodiment of the invention, an online rating of a condition of the construction asset may be provided which is based on the inspection report. The rating may comprise a numerical rating corresponding to an expected remaining life span of the construction asset. In addition, the numerical rating may be color coded, with different colors being associated with different ranges of the numerical ratings. The rating may be updated after each repair to the construction asset.

A plurality of inspection reports corresponding to a plurality of construction assets of the asset owner may be archived. The plurality of construction assets may be located at multiple locations. Computerized reports may be generated relating to one or more of the plurality of construction assets. The computerized reports may be generated according to at least one of age of the construction asset, a rated condition of the construction asset, a type of the construction asset, recommended repairs listed on the inspection report, date of construction, date of last repair, expected remaining lifetime of the construction asset, contractors responsible for construction of or repairs to the construction asset, a location of the construction asset, repair history, repair type, repair costs, defect history, and the like

A further example embodiment in accordance with the present invention may include the provision of online bid information for a construction project related to the construction asset. An online bid submission form may be provided to a plurality of contractors for use in submitting a bid on the project. The contractors may then review the online bid information and, if desired, submit a bid online using the bid submission form. The asset owner can be provided with online access to the submitted bids in order to selecting a winning bid from the submitted bids. The project can then be awarded to a contractor that posted the winning bid. The contractor may be notified by email of the project award. A contract for signature by the asset owner and the contractor that is awarded the winning bid may be automatically generated based on the winning bid and the bid information.

The online bid information may comprise at least one of project specifications, project drawings, and the archived inspection reports for the construction asset related to the project. The online bid information may further comprise at least one of photographs of the construction asset and video clips of the construction asset.

The bid submission form may comprise areas for entering at least one of: an amount of the bid, contractor contact information, contractor references, contractor qualifications, dates of availability, contractor questions regarding the project, and any other information which may be needed by the contractor to make a knowledgeable bid.

The project may comprise at least one of: repair of a roof leak, roof replacement, building repair, building renovation, building remodeling, driveway repair, driveway re-paving, parking lot repair, parking lot re-paving, window repair, window replacement, gutter repair, gutter replacement, interior painting, exterior painting, erection of a commercial or residential structure, demolition of a commercial or residential structure, or virtually any other type of construction project, whether residential or commercial.

Project reports detailing periodic progress for the project may be posted online. The project reports may be archived. The project reports may comprise at least one of a description of project activities for the current day, photographs of the project activity for the current day, video clips of the project activity for the current day, weather conditions, crew head count, contractor's representatives on site, site conditions, a quality control report, description of project delays, change order descriptions, warranty information for materials installed, as well as any other information relating to the project.

Computerized reports may be generated from the archived project reports. The computerized reports may be generated according to at least one of project date, contractor, project type, project costs, construction asset location, or the like. Email notification may be provided to the asset owner notifying the asset owner of the posting of the project reports.

In an example embodiment of the present invention, a fee may be charged to the asset owner for the posting of each of the project reports. A fee may also be charged to the asset owner for providing the online bid information for the construction project. Each contractor may be charged a fee for each bid submission made. Further, a winning bid fee may be charged to the contractor that submitted the winning bid. A fee may also be charged to the asset owner for providing the online inspection report and/or for providing the online access to the inspection report.

In a further example embodiment of the present invention, the online bidding process may be extended to material suppliers that supply project materials to the contractor. The material suppliers may be provided with online access to the bid information for the project. A second online bid submission form may be provided to each material supplier for use in submitting a bid on materials to be supplied for the project. At least one of the contractor and the asset owner may be provided with online access to submitted material supplier bids. The contractors can then in turn select a material supply bid and use that information in submitting its bid on the project. Each material supplier may be charged a fee for each bid submission made by the material supplier.

The construction asset may comprise a roof, a driveway, a parking lot, a building structure, a building lot, or any other type of construction asset.

The present invention also includes a system for implementing the foregoing methods. An example embodiment of a system for the online management of a construction asset in accordance with the present invention includes a database for archiving inspection reports, each of which relate to a current condition of a construction asset. The system also includes a web browser for providing an asset owner with online access to the archived inspection reports. A server responsive to the web browser is provided for accessing the database to retrieve a requested inspection report.

Such a system may be used to implement the methods of the invention discussed above. For example, the database may also be used to store the online bid information and the project reports. The server may comprise an application server which stores software for carrying out the methods for managing the construction asset discussed above. In addition, the server may store software for carrying out the design and bid methods discussed above. The server may also include a report generator function for generating reports in response to user queries from the web browser, which may run on a conventional personal computer.

### BRIEF DESCRIPTION OF THE DRAWINGS

The present invention will hereinafter be described in conjunction with the appended drawing figures, wherein like reference numerals denote like elements, and:

FIG. 1 shows a block diagram of an example embodiment of the present invention; and

FIG. 2 shows a block diagram of an example embodiment of the database shown in the example embodiment of FIG. 1.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

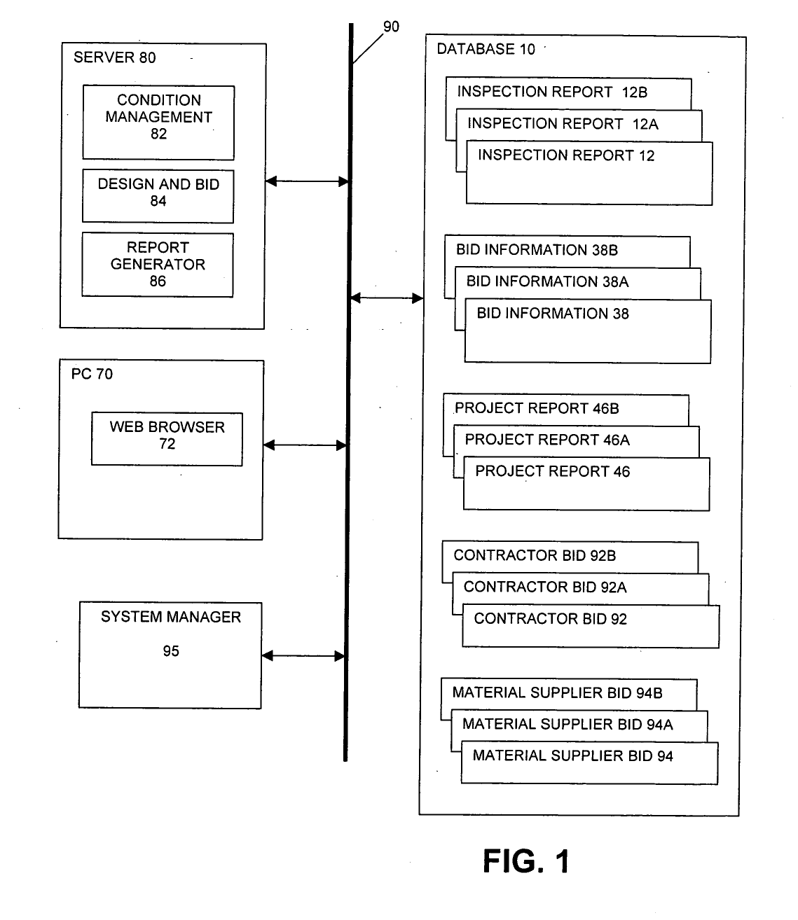

Computerized methods and systems for the online management of a construction asset are provided in accordance with the present invention. In accordance with one example embodiment as shown in FIG. 1, an online inspection report 12 relating to a current condition of a construction asset may be archived in a database 10. An asset owner is then provided with online access to the archived inspection report 12 via a web browser 72 running on a conventional personal computer 70. A server 80 responsive to the web browser 72 is provided for accessing the database 10 to retrieve a requested inspection report 12.

The term “asset owner” as used throughout the description and the claims is meant to encompass not only the legal owner of an asset, but also any person or entity responsible for maintaining or managing the asset.

The inspection report 12 may be provided in the form of a web page from the server 80 to the browser 72. Alternatively, the inspection report 12 may be downloaded as a text file from the database 10 to the personal computer 70 via the server 80.

The server 80 may comprise an application server that includes condition management software 82. The condition management software 82 may be responsive to queries from the web browser 72, access the database 10, and provide the inspection report 12 in a format suitable for display on the browser 72 or storage on personal computer 70.

The online access may be provided via a network 90. The network 90 may comprise the Internet, a local area network, a large area network a global area network, a telephone network, a virtual private network, or the like. The network 90 may further comprise a combination of different types of interconnected networks.

The database 10 may be implemented as a database server as shown in FIG. 1 that is remote from the server 80. Alternatively, as would be apparent to those skilled in the art, the database 10 may be implemented as part of the server 80.

The construction asset may comprise a roof, a driveway, a parking lot, a building structure, a building lot, or virtually any other type of construction asset.

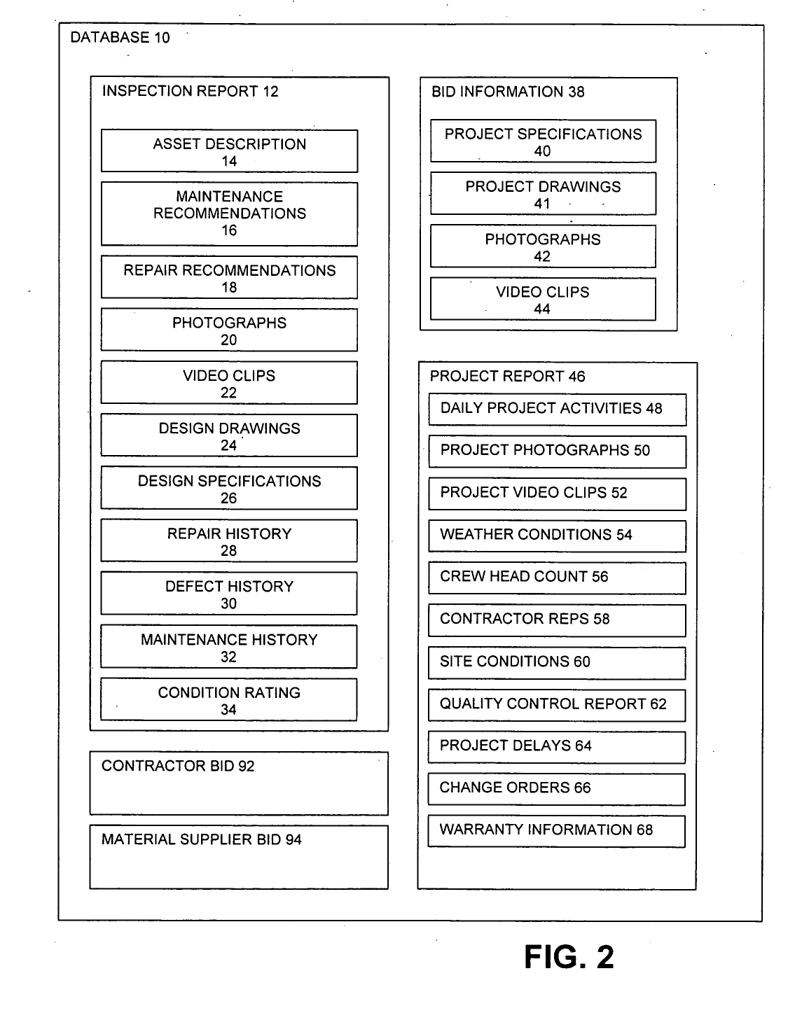

FIG. 2 shows an example of the types of information that may be stored on database 10 for a single construction asset in accordance with the present invention. As shown in FIG. 2, the inspection report 12 may include at least one of a description of the construction asset 14, recommendations regarding maintenance of the construction asset 16, recommendations regarding current repairs to the construction asset 18, photographs of the construction asset 20, video clips of the construction asset 22, design drawings (e.g., CAD drawings) of the construction asset 24, design specifications of the construction asset 26, repair history 28, defect history 30, maintenance history 32, and the like. The photographs 20 may provide a visual history of the construction asset by providing photos before and after any repairs. Similarly, the video clips 22 may comprise videos of the asset before and after any repairs.

A web page displaying the inspection report 12 for a particular asset may include links to additional web pages containing the asset description 14, maintenance recommendations 16, repair recommendations 18, photographs 20, video clips 22, design drawings 24, design specifications 26, repair history 28, defect history 30, maintenance history 32, and the like.

Sections of the web pages showing the design drawings 24 may include hyperlinks to at least one of the photographs 20 and the video clips 22 that show a portion of the construction asset corresponding to the section of the drawing, thus providing a virtual tour of the construction asset.

In a further example embodiment of the invention, an online rating 34 of a condition of the construction asset may be provided which is based on the inspection report 12. The rating 34 may appear as part of the inspection report 12 or on the web page displaying the inspection report 12. The rating may comprise a numerical rating corresponding to an expected remaining life span of the construction asset. In addition, the numerical rating may be color coded, with different colors being associated with different ranges of the numerical ratings. The rating may be based on the geographic location of the asset, its current age, he type of asset, construction details, repair history, and defect history. The rating may be updated after each repair to the construction asset.

In an example embodiment of a rating system in accordance with the present invention, the rating system may automatically assign an updated rating to each asset (or part of an asset) based on its geographic location, age, asset type, construction, repair history, defect history, and the like. The rating may be a numerical rating assigned based on a percentage of estimated life remaining until replacement or repair is recommended, which may be determined after inspection. For example, a rating of between 0-35% may indicate that an asset is in need of replacing or repairing immediately (e.g., 0%) or up to within the next two years (e.g., 35%); a rating of between 36-49% may indicate that the asset will need to be replaced or repaired within the next three to five years; a rating of between 50-74% may indicate that the asset is maintainable and should be inspected annually; a rating of between 75-100% may indicate that the asset is in good condition and should be inspected annually. As discussed above, the rating system may also be color-coded to provide a quick indicator as to the condition of the asset. For example, a section of the web page containing the rating may be color-coded (e.g., red may be associated with a rating of between 0-35%, orange may be associated with a rating of between 36-49%, yellow may be associated with a rating of between 50-74%, and green may be associated with a rating of between 75-100%).

As shown in FIG. 1, a plurality of inspection reports (e.g., inspection reports 12, 12A, and 12B) corresponding to a plurality of construction assets of the asset owner may be archived on the database 10. The plurality of construction assets may be located at multiple locations. The asset owner may be provided with access to a web page listing all construction assets owned by the asset owner (e.g., an asset owner home page). Links may be provided on the asset owner home page to additional web pages dedicated to each asset. For example, a web page dedicated to each asset may include hyperlinks to the information shown in database 10 of FIG. 2 for that asset.

For example, the asset owner may be a large corporation owning several assets across the country or around the world. The asset owner/manager may log in to a secure section of a web site to reach a web page containing the asset owner's information. The asset owner may select a region or state. A web page will be generated showing a list of all assets in that state or region that have been entered into the system (e.g., by the system manager 95). The list may be sorted by location and may provide an asset number, an address of the asset, asset sections, an asset name, manager name and telephone number, year constructed, type of asset, size of asset, and various links to other asset details and the inspection reports. Also included in the asset list is a rating for each asset, as discussed above. The asset owner may then view the inspection report 12 for the asset in question by clicking on a link provided on the web page for that asset.

Each asset may be managed in separate sections, depending on its size, or as a whole. The list of assets will indicate the number of sections being managed. Detailed inspection and reporting information may then be provided by asset section. For example, if an asset is indicated as having a single section, the asset is being managed as a whole and not separated into sections. A section page indicating the sections which are being managed for each asset may be provided. If more than one section is being managed, each section will be listed separately. Separate links to web pages containing information about each particular section of the asset may be provided.

The server 80 may also include a report generator function 86 for generating computerized reports in response to user queries from the web browser 72. The reports may be provided in the form of web pages from the server 80 to the browser 72. The computerized reports may relate to one or more of the plurality of the construction assets and be generated according to at least one of age of the construction asset, a rated condition of the construction asset, a type of the construction asset, recommended repairs listed on the inspection report 12, date of construction, date of last repair, expected remaining lifetime of the construction asset, contractors responsible for construction of or repairs to the construction asset, a location of the construction asset, repair history, repair type, repair costs, defect history, and the like

An example embodiment of the present invention may further include the provision of bid information 38 for a construction project related to the construction asset. An online bid submission form may be provided to a plurality of contractors for use in submitting a bid on the project. Contractors (e.g., area, regional, or national contractors) may be notified by email of the bidding for the project and provided with access to the bid submission form and bid information 38. The bid submission form may be generated by a system manager 95 via the design and bid software 84 running on the server 80. The bid submission form may be provided as a web page on the web browser 72. The contractors may then review the online bid information 38 and, if desired, submit a bid online using the bid submission form. Contractor bids (e.g., contractor bids 92, 92A, and 92B) may be stored on the database 10. The asset owner can be provided with online access to the submitted bids 92, 92A, and 92B in order to selecting a winning bid from the submitted bids. For example, a web page may be provided to the browser 72 summarizing the submitted bids. Links may be provided on the web page to each bid submission form submitted by the contractors.

The project can then be awarded to a contractor that posted the winning bid. The contractor may be notified by email of the project award. The contractor that is awarded the winning bid may then be given online access to the bid information 38 and inspection reports 12 relating to the project at issue. A binding contract can be automatically generated (e.g., at design and bid software 84) for signature by the asset owner and the contractor based on the bid information 38 and the bid submission form (e.g., contractor bid 92) of the contractor that is awarded the project.

The online bidding process of the present invention may be extended to material suppliers that supply material for the project to the contractors. Material suppliers can submit online bids (e.g., material supplier bids 94, 94A, and 94B) for supplying project material in much the same way as a contractor is allowed to bid on a project. For example, relevant material suppliers can be notified of the bid opportunity by email at the same time as the contractors are notified. The notified material suppliers can be provided with online access to the bid information 38 to obtain the relevant list of materials from the project specifications 40. Online bid forms for project materials may be provided to the material suppliers. Online access to submitted material supplier bids 94, 94A, and 94B may be provided to the asset owner and/or the contractors bidding on the project. The contractors may select one of the material supplier bids 94, 94A, or 94B to use in the contractor's bid submission for the project.

Those skilled in the art will appreciate that while FIG. 1 shows only one personal computer 70 connected to the network 90, a plurality of computers with web browsers may be connected to the network 90 for use by the asset owner, contractors, and material suppliers respectively. The present invention further contemplates that an asset owner may access the online system using a separate and secure web page running on its own personal computer 70. Contractors may be provided with secure access that is limited to the bid submission forms and bid information 38. Material suppliers may be provided with secure access that is limited to the bid information 38. Access may be protected using different passwords allowing differing levels of access to the system and the information stored therein.

Online consultation for the design of the construction project may be provided based on the archived inspection report 12 for the asset before the project is set up to bid. For example, each project design may be reviewed by licensed architects or engineers before being displayed for bid purposes. Such design consultation may include a review of the inspection report(s) for the asset, development of project specifications, and assistance in selecting the materials and/or systems to be used in the construction project. The bid information 38 may be assembled based on this consultation.

As shown in FIG. 2, the online bid information 38 may comprise project specifications 40 and project drawings 41. As part of the bid process, a bidding contractor may also be allowed access to any archived inspection reports 12 for the construction asset involved in the project. The online bid information 38 may further comprise at least one of photographs 42 of the construction asset and video clips 44 of the construction asset. These photographs 42 and video clips 44 may be the same as the photographs 20 and video clips 22 stored in connection with the inspection report 12. Alternatively, these photographs 42 and video clips 44 may be specifically related to the construction project, which may be different than those stored in connection with the inspection reports 12.

The bid information 38 may be provided to the contractors in the form of a web page having links to additional web pages displaying the project specifications 40, project drawings 41, photographs 42, video clips 44, and the like.

As shown in FIG. 1, an asset owner may be provided with access to archived bid information relating to different construction projects for that asset owner (e.g., bid information 38, 38A, 38B).

The bid submission form may comprise areas for entering at least one of: an amount of the bid, contractor contact information, contractor references, contractor qualifications, dates of availability, contractor questions regarding the project, and any other information which may be needed to make a knowledgeable bid. The bid submission form may also include an area for the contractor to inform the asset owner about its company in detail, essentially providing a marketing tool to the contractor for use in selling itself to the asset owner. Information from the bid submission form is stored as a contractor bid 92 on the database 10. This information can then be viewed by the asset owner in the form of a web page on the browser 72.

The project may comprise at least one of: repair of a roof leak, roof replacement, building repair, building renovation, building remodeling, driveway repair, driveway re-paving, parking lot repair, parking lot re-paving, window repair, window replacement, gutter repair, gutter replacement, interior painting, exterior painting, erection of a commercial or residential structure, demolition of a commercial or residential structure, or virtually any other type of construction project, whether residential or commercial. For example, where the construction asset comprises a roof, the construction project may comprise a roof replacement or repair project. Where the construction asset comprises a driveway or a parking lot, the construction project may comprise re-paving or repair of the driveway or parking lot. Where the construction asset comprises a building structure, the construction project may comprise painting, roof repair or replacement, gutter repair or replacement, window repair or replacement, or the like. Where the construction asset comprises a building lot, the construction project may comprise the erection or demolition of a building structure, parking lot, or the like.

Project reports 46 detailing periodic progress for the project may be posted online. The progress reports 46 may be provided at any interval desired by the asset owner. For example, the project reports may be provided daily or weekly, or once certain project milestones are achieved. The project reports (e.g., project reports 46, 46A, and 46B) may be archived on the database 10. The project report 46 may comprise at least one of a description of project activities for the current day 48, photographs of the project activity for the current day 50, video clips of the project activity for the current day 52, weather conditions 54, crew head count 56, a list of contractor's representatives on site 58, site conditions 60, a quality control report 62, description of project delays 64, change order descriptions 66, warranty information for materials installed 68, as well as any other information relating to the project.

The project reports 46, 46A, 46B may be provided to the asset owner in the form of web pages on the browser 72. For example, links to the project reports 46, 46A, 46B for a particular project may be provided on a web page dedicated to that particular asset. A web page for a particular project report 46 may include separate links to all the information contained in that report, including project activities 48, photographs 50, video clips 52, weather conditions 54, crew head count 56, contractor representatives 58, site conditions 60, quality control reports 62, project delays 64, warranty information 68, and the like. Alternatively, the project report 46 may be downloaded as a text file from the database 10 to the personal computer 70 via the server 80.

An asset manager of a large corporation may be responsible for a large number of assets located across the country. The present invention provides the asset manager with the capability to view all current projects on the web site by logging in to a secure portion of the web site dedicated to that particular asset owner/corporation. The projects may be sorted and accessed by geographical location, state, etc. A web page listing all projects for the asset owner may include the project reports 46, 46A, and 46B for each listed asset, providing online reporting of each day's activities at ongoing projects.

In addition, computerized reports may be generated from the archived project reports 46, 46A, and 46B (e.g., via report generator 86). The computerized reports may be generated according to at least one of project date, contractor, project type, project costs, construction asset location, or the like. The reports may be provided in the form of a web page on the browser 72. Email notification may be provided to the asset owner notifying the asset owner of the posting of the project reports 46.

A system manager 95 may be responsible for maintaining the server 80 and database 10, as well as entering data into the database 10. In an example embodiment of the present invention, the system manager 95 may charge a fee to the asset owner for the posting of each of the project reports 46. The system manager 95 may also charge a fee for verifying the contractor references included on the bid submission form. The system manager 95 may also charge the asset owner a fee for providing the online bid information 38 for the construction project. Each contractor may be charged a fee for each bid submission made. Further, a winning bid fee may be charged to the contractor that submitted the winning bid. A fee may also be charged to the asset owner by the system manager 95 for providing the online inspection report 12 and/or for providing the online access to the inspection report 12 via the server 80.

As an example, the fees associated with the present invention may be established by the system manager 95 as follows:

I. Internet Based Design and Bid Procurement Fees:

A. Asset Owner

Cost of service to the asset owner may be charged on a per asset basis. Additional charges may be associated with larger projects. For example, where the project is a roof replacement project, the asset owner may be charged $999.00 plus tax per building for 0-50,000 square feet. For projects over 50,000 square feet, an additional $0.02 per square foot may be charged.

B. Contractors

There are Two (2) Separate Costs to Contractors:

### 1. Bid Fees

Contractors and sub-contractors may be charged a fee to reserve the opportunity to view pertinent project information and to have the opportunity to submit a bid for each project. As an example, this fee may range between $100 and $150 depending on the size and scope of the project.

The bid fees will vary and are displayed above the Project Description for each project. The asset owner's representative will be notified of the determined bid fees prior to the project being displayed for bid purposes.

### 2. Winning Bid Fee—Only Charged to Contractors Awarded the Project

The contractor that is awarded the project by the asset owner will be charged a winning bid fee, which may be based on the size of the project or bid. For example, if the project is a roof replacement, the contractor awarded the project may be charged a fee of $0.04 per square foot of project roof size. Minimum/maximum charges may be established. For example, a minimum charge of $1,500 and a maximum charge of $2,500 may apply to each roof project. The specific fee will be displayed above the Project Description for each project.

C. Inspections

A per-day or per-hour cost for inspection services during the project may be charged. For example, a cost per-day for full time inspections may be set at $ 400.00 plus applicable sales tax.

II. Condition Management Fees:

A. Asset Set Up

The asset owner may be charged a one-time flat fee to set up each asset in the database. For example, a flat fee of $500.00 plus tax per store may be charged.

B. Annual Fee for Software, Storage of Data and Customer Service

The asset owner may be charged a yearly fee for use of the software, online storage of data, and customer service. For example $100.00 per asset per year may be charged by the system manager 95.

Benefits to the asset owner of the condition management aspect of the present invention include:
No longer will asset owners need to pay thousands of dollars for an up-to-date condition report for their construction assets. For a small annual per asset fee, the present invention makes the management of this information extremely cost effective.
Costly decisions to repair or replace an asset can be made quickly based on the most current information provided by the condition management software versus out of date condition reports.
Repair work can be verified, repair history can be researched and contractors can be held accountable for the quality of their repair work.
A large number of assets can be easily managed.

Benefits to the asset owner of the design and bid aspect of the present invention include:
Inexpensive high quality design may save the asset owner as much as 75% off current industry fees for the same design.
Convenient time saving way of securing bids for their construction project; the need to contact contractors and escort them to the asset is eliminated.
The bid opportunity is available to a wider range of contractors, which identifies the contractors that are in an aggressive position in their work flow cycle to really “go after the work” in the form of a lower bid.
Increased competition among contractors, material suppliers, and sub-contractors lead to lower overall bid prices.
The asset owner is introduced to previously unknown contractors within a regional market that can provide repair and maintenance services.
The asset owner's regular contractor and material suppliers are kept competitive.
Eliminates collusion possibilities among asset owner's staff, industry consultants, material suppliers, or contractors.

Benefits to the asset owner of the online archived project reports include:
It will be much easier to retrieve valuable information in the future regarding the identity of the contractor that worked on the project and the identity of the manufacturer that carries the long-term warranty for materials used on the project.
Years from now if there is a problem with any part of the asset, the specific site inspection reports for that project can be easily accessed to determine if the contractor or the material manufacturer should be held accountable for the problem.
The record of each online visit to the project reports by the material manufacturer will serve as a valuable resource to hold the material manufacturer accountable for the workmanship of their certified installing contractor.

The present invention provides the asset owner or manager with an easily accessible resource to assist them in easily managing an asset and conducting a successful construction project relating to the asset. The condition management aspect of the present invention provides asset owners with a way to affordably track the condition of multiple assets online. The condition management software 82 software provides asset managers with up to date asset conditions based on the most recent maintenance inspection, repair, or maintenance performed on the asset. The bid procurement process of the present invention generates lower bids, accountability for the contractor, and peace of mind that the right system and approach has been specified for the project. The present invention provides time and money savings to the asset owner, as well as an online archived record of each inspection report and of each project report.

It should now be appreciated that the present invention provides advantageous methods and apparatus for the online management of a construction asset, including the designing of and bidding on a construction project relating to the asset.

Although the invention has been described in connection with various illustrated embodiments, numerous modifications and adaptations may be made thereto without departing from the spirit and scope of the invention as set forth in the claims.

1. A computerized method for the online management of a construction asset, comprising:
providing an online inspection report relating to a current condition of a construction asset;
archiving said inspection report; and
providing an asset owner with online access to said archived inspection report.

2. A method in accordance with claim 1, wherein:
said inspection report includes at least one of a description of said construction asset, recommendations regarding maintenance of said construction asset, recommendations regarding current repairs to said construction asset, photographs of said construction asset, video clips of said construction asset, design drawings of the construction asset, design specifications of said construction asset, repair history, defect history, and maintenance history.

3. A method in accordance with claim 2, wherein:
sections of said design drawings include hyperlinks to at least one of said photographs and said video clips which show a portion of the construction asset corresponding to the section of the drawing.

4. A method in accordance with claim 1, further comprising:
providing an online rating of a condition of said construction asset based on said inspection report.

5. A method in accordance with claim 4, wherein:
said rating comprises a numerical rating corresponding to an expected remaining life span of said construction asset.

6. A method in accordance with claim 5, wherein:
said numerical rating is color coded, with different colors being associated with different ranges of said numerical ratings.

7. A method in accordance with claim 4, wherein:
said rating is updated after each repair to said construction asset.

8. A method in accordance with claim 1, wherein:
a plurality of inspection reports corresponding to a plurality of construction assets of said asset owner are archived.

9. A method in accordance with claim 8, wherein:
said plurality of construction assets are located at multiple locations.

10. A method in accordance with claim 8, further comprising:
generating computerized reports relating to one or more of said plurality of construction assets.

11. A method in accordance with claim 10, wherein:
said computerized reports are generated according to at least one of age of said construction asset, a rated condition of said construction asset, a type of said construction asset, recommended repairs listed on said inspection report, date of construction, date of last repair, expected remaining lifetime of said construction asset, contractors responsible for construction of or repairs to said construction asset, a location of said construction asset, repair history, repair type, repair costs, and defect history.

12. A method in accordance with claim 1, further comprising:
providing online bid information for a construction project related to said construction asset;
providing an online bid submission form to a plurality of contractors for use in submitting a bid on the project;
providing said asset owner with online access to said submitted bids;
selecting a winning bid from said submitted bids; and
awarding the project to a contractor that posted the winning bid.

13. A method in accordance with claim 12, wherein:
said online bid information comprises at least one of project specifications, project drawings, and said archived inspection reports.

14. A method in accordance with claim 13, wherein:
said online bid information further comprises at least one of photographs of said construction asset and video clips of said construction asset.

15. A method in accordance with claim 12, wherein:
said project comprises at least one of: repair of a roof leak, roof replacement, building repair, building renovation, building remodeling, driveway repair, driveway re-paving, parking lot repair, parking lot re-paving, window repair, window replacement, gutter repair, gutter replacement, interior painting, exterior painting, erection of a commercial or residential structure, and demolition of a commercial or residential structure.

16. A method in accordance with claim 12, further comprising:
posting online project reports detailing periodic progress for said project.

17. A method in accordance with claim 16, further comprising:
archiving said project reports.

18. A method in accordance with claim 16, wherein:
said project reports comprise at least one of a description of project activities for the current day, photographs of said project activity for said current day, video clips of said project activity for said current day, weather conditions, crew head count, contractor's representatives on site, site conditions, a quality control report, description of project delays, change order descriptions, and warranty information for materials installed.

19. A method in accordance with claim 17, further comprising:
generating computerized reports from said archived project reports.

20. A method in accordance with claim 19, wherein:
said computerized reports are generated according to at least one of project date, contractor, project type, project costs, and construction asset location.

21. A method in accordance with claim 16, further comprising:
providing email notification to said asset owner notifying said asset owner of said posting of said project reports.

22. A method in accordance with claim 16, further comprising:
charging a fee to said asset owner for said posting of said project reports.

23. A method in accordance with claim 12, further comprising:
charging a fee to said asset owner for providing said online bid information for said construction project.

24. A method in accordance with claim 12, further comprising:
charging each contractor a fee for each bid submission made by said contractor; and
charging a winning bid fee to said contractor that submitted the winning bid.

25. A method in accordance with claim 12, wherein:
said bid submission form comprises areas for entering at least one of: an amount of said bid, contractor contact information, contractor references, contractor qualifications, dates of availability, and contractor questions regarding said project.

26. A method in accordance with claim 12, further comprising:
providing said online bid information for said project to material suppliers;
providing a second online bid submission form to each material supplier for use in submitting a bid on materials to be supplied for the project;
providing at least one of said contractor and said asset owner with online access to submitted material supplier bids.

27. A method in accordance with claim 26, further comprising:
charging each material supplier a fee for each bid submission made by said material supplier.

28. A method in accordance with claim 12, further comprising:
automatically generating a contract for signature by the asset owner and the contractor that is awarded the winning bid based on the winning bid and said bid information.

29. A method in accordance with claim 1, further comprising:
charging a fee to said asset owner for at least one of providing said online inspection report and providing said online access.

30. A method in accordance with claim 1, wherein:
said construction asset comprises one of a roof, a driveway, a parking lot, a building structure, or a building lot.

31. A system for the online management of a construction asset, comprising:
a database for archiving inspection reports, each of which relate to a current condition of a construction asset;
a web browser for providing an asset owner with online access to said archived inspection reports; and
a server responsive to said web browser for accessing said database to retrieve a requested inspection report.
